(19) United States
(12) Patent Application Publication
(10) Pub. No.: US 2013/0192489 A1
(43) Pub. Date: Aug. 1, 2013

(54) PROCESS FOR PRODUCING CELLULOSE FILM

(71) Applicants: Martin Cockcroft, Wigton (GB); Colin Marshall, Wigton (GB)

(72) Inventors: Martin Cockcroft, Wigton (GB); Colin Marshall, Wigton (GB)

(73) Assignee: INNOVIA FILMS LIMITED, Wigton,Cumbria (GB)

(21) Appl. No.: 13/805,885

(22) PCT Filed: Jun. 21, 2011
(86) PCT No.: PCT/GB2011/051159

§ 371 Date: Apr. 17, 2013

(30) Foreign Application Priority Data
Jul. 7, 2010 (GB) 1011446.0

(51) Int. Cl. C09D 7/00

(52) U.S. Cl. CPC C09D 7/001
USPC 106/200.2; 106/163.01; 106/202.1; 106/311

(57) ABSTRACT

The present invention provides a process for producing a cellulose film in which a) cellulose is at least partly dissolved at a temperature of about 100° C. or lower in a dope comprising an ionic liquid and a cosolvent to form a cellulose solution, wherein said cosolvent comprises a polar aprotic component, and B) cellulose film is cast from the cellulose solution.

This application is a national stage application of International Patent Application No. PCT/GB2011/051159 filed on Jun. 21, 2011, which claims priority of British Patent Application No. 1011446.0, filed on Jul. 7, 2010. The entirety of all of the aforementioned applications is incorporated herein by reference.

### BACKGROUND

The present invention generally relates to a process for casting a film and, more particularly, to a process involving the use of a dope comprising cellulose, ionic liquid and a cosolvent having aprotic character.

Cellulose film has been known for many years and was first developed by Swiss chemist, Jacques E. Brandenberger. Cellulose film has been widely available since the 1930s and is still used today. Although primarily used in the packaging of food items, it also has many industrial applications which include acting as bases in self-adhesive tapes, as a semi-permeable membrane in electrochemical cells, and as a release liner for certain fibre glass and rubber products.

One of the most commonly used methods of manufacturing cellulose films involves dissolving cellulose from wood, cotton, hemp, or other natural sources in alkali and carbon disulfide to make a solution called viscose. This liquid is filtered and refiltered in order to maximise the purity of the material to improve film quality. The viscose is then extruded through a slit into a bath of dilute sulfuric acid and sodium sulfate to regenerate cellulose from the viscose.

The extruded cellulose film is passed through several rollers and additional baths to clean and soften the film and to obtain the desired optical and mechanical properties.

The solvents used in traditional processes for manufacturing cellulose sheets are problematic for several reasons. For example, their cost is high. Additionally, their ionic strength is high and steps must be taken to prevent the formation of unwanted byproducts. For example, those solvents may need to be stored and handled in inert environments. Further, the vessels in which those solvents are stored and used must be selected from materials having a high degree of chemical resistance.

Attempts have been made to identify new solvents which can be used to dissolve cellulose. One group of materials which have shown promise in this area are ionic liquids.

EP1458805 discloses processes for dissolving cellulose in dopes comprising ionic liquid and which are substantially free of other materials, especially nitrogen-containing bases, water and other solvents. While cellulose is soluble in the dopes disclosed in EP1458805, those dopes are highly viscous. This high viscosity limits the utility of those dopes in equipment used to dissolve and cast cellulose using the viscose process. Additionally, the dopes disclosed in EP1458805 are preferably free of water and other solvents and thus include a high proportion of costly ionic liquid. For this reason, the cost of preparing cellulose sheets from the dopes disclosed in EP1458805 is relatively high.

US2009/0084509 discloses a process in which dopes comprising ionic liquid and a protic or aprotic cosolvent are employed. Again, cellulose was soluble in those dopes. However, low viscosity levels were only exhibited when a low amount of cellulose was dissolved in those dopes. Further, high temperatures, of over 100° C., were required to bring about the dissolution of cellulose in the dopes exemplified therein. The majority of the dopes exemplified in US2009/0084509 which were reported as exhibiting good rates of cellulose dissolution included ionic liquid as the major constituent. Ideally, the amount of costly ionic liquids used in dopes for cellulose should be reduced.

### BRIEF DESCRIPTION OF THE DRAWINGS

FIG. 1 is a chart illustrating the ball fall velocities reported in Examples 1, 4, 5 and 6.

FIG. 2 shows the result of ball fall velocity measurements in the solutions at varying temperatures in both an ambient atmospheric environment (i.e. in the presence of air) and in a protected environment.

FIG. 3 illustrates all fall velocity viscosity measurements were made in each of the solutions across a range of temperatures.

### DETAILED DESCRIPTION

The present invention seeks to provide an industrial-scale process for the preparation of cellulose films in which a dope is employed that requires an acceptably low input of thermal energy to enable the dissolution of cellulose, which utilises a relatively low amount of ionic liquid, which has a sufficiently low viscosity to enable its use with conventional equipment such as viscose manufacturing machinery, which can reliably dissolve significant amounts of cellulose, which can be used to dissolve less refined or less reactive pulps, which are stable without the need for storage in inert atmospheres, and which can be modified to control the density and mechanical properties of cellulose films.

From the discussion that is to follow, it will become apparent that the present invention addresses some or all of the aforementioned deficiencies while providing numerous additional advantages not hitherto contemplated.

Thus, according to a first aspect of the present invention, there is provided a process for producing a cellulose film in which a) cellulose is at least partly dissolved at a temperature of 100° C. or less in a dope comprising an ionic liquid and a cosolvent to form a cellulose solution, wherein said cosolvent comprises a polar aprotic component and b) cellulose film is cast from the cellulose solution.

The dissolution of cellulose preferably takes place in a reaction vessel or chamber. Advantageously, the dope is relatively inert with respect to the materials from which such vessels and tanks are conventionally formed and thus apparatus may be employed that would have been incompatible with traditional cellulose dissolution methods.

The thermal energy necessary to achieve dissolution of the cellulose in the dope may be provided using any means known in the art, including heat exchange apparatus or microwave radiation. While dissolution temperatures of 100° C. or lower constitute considerable improvements over the processes of the prior art, the present invention advantageously enables the dissolution of cellulose at temperatures of about 90° C. or lower, about 80° C. or lower, about 75° C. or lower or even about 70° C. or lower. In preferred embodiments of the present invention, the dissolution temperature ranges from these maxima to minima in the order of about 25° C. or higher, about 30° C. or higher, about 40° C. or higher, about 50° C. or higher or about 60° C. or higher.

Additionally, the dopes utilised in the processes of the present invention are not generally reactive with air and thus, there is no need to provide an inert gas blanket when those dopes are being stored, handled or used.

In preferred embodiments of the present invention, the cellulose is totally dissolved in the dope. However, functioning embodiments of the invention will be achievable where a proportion of cellulose remains in solid or semi solid form. Depending on the desired properties of the film which is to be produced, differing amounts of non-dissolved cellulose may be tolerated in the cellulose solution. Additionally, the solid or semi-solid cellulose material can be removed by filtration of the solution prior to casting. Alternatively, total dissolution can be achieved in the processes of the present invention by increasing the temperature of the solution, preferably to temperatures not higher than 100° C.

The processes of the present invention advantageously make the use of dopes which do not necessarily include ionic liquids as the principal constituents in order to exhibit acceptable rates of dissolution. Preferably, the amount of ionic liquid in the dope is less than 50% by weight of the dope.

In US2009/0084509, dopes consisting of ionic liquid and aprotic solvent in ratios of 20:80 and 50:50 by weight of the dope were reported as being largely incapable of dissolving cellulose at temperatures of 105° C.

It has been found that cellulose can be dissolved at temperatures of 90° C. in the dopes used in the processes of the present invention which include 20% and 50% ionic liquid by weight of the dope.

Unexpectedly, it was found that when dopes were used comprising between 20 and 50% ionic liquid by weight of the dope, i.e. more than 20% or less than 50% of the dope, the temperature required to bring about dissolution of cellulose was reduced. Thus, according to a preferred aspect of the present invention, the dope comprises between about 20% and about 50% ionic liquid by weight of the dope. In especially preferred embodiments of the present invention, the dope comprises about 25% to about 45% ionic liquid, about 25% to about 40% ionic liquid, or more preferably, about 25% to about 35% ionic liquid by weight of the dope.

According to a second aspect of the present invention, there is provided a dope for dissolving cellulose comprising a polar aprotic component and between 20% and 50% by weight of the dope of an ionic liquid. For the avoidance of any doubt, where reference is made to a feature or characteristic of a dope as employed in the processes of the present invention, that feature or characteristic may also be exhibited by the dope of this second aspect of the present invention, which does not necessarily have to be employed in the process of the first aspect of the present invention.

In the processes of the present invention, the dope may be prepared and cellulose added thereto. However in an especially preferred embodiment, the cellulose and the polar aprotic component of the cosolvent are premixed prior to being contacted with the ionic liquid to form the dope and cellulose solution. This allows the polar aprotic component, which functions as an interstitial swelling agent, to promote the rapid dissolution of cellulose in the dope.

The cosolvent may consist exclusively or essentially of the polar aprotic component, or may include other materials in amounts sufficient to impart a chemical effect on the dope.

Any polar aprotic component may be included in the dope. Particularly preferred polar aprotic components include dimethyl sulfoxide (DMSO), dimethylacetamide (DMAc), Tetrahydrofuran (THF), dimethylformamide (DMF), formamide, N-methylmorpholine-N-oxide, pyridine, acetone, dioxane, N-methylpyrrolidone, piperyline sulfone and hexamethylphosphoramide or mixtures thereof.

In arrangements where the cosolvent comprises additional components besides the polar aprotic component, any material/s may be included provided that their inclusion in the dope does not adversely affect the solubility of cellulose to the extent that a dissolution temperature of greater than 100° C. is required to at least partly dissolve the cellulose.

In a preferred embodiment, a base is included in the dope in addition to the polar aprotic component. The base is preferably organic and may optionally contain heteroatoms. In an especially preferred embodiment, the base is a nitrogen containing base such as ammonia, piperidine, morpholine, diethanolamine or triethanolamine, pyridine, triethylamine or urea. The base may be present in amounts ranging from 1 to 10% by weight of the dope. In especially preferred embodiments, 3% to 8% or 4% to 7% base by weight of the dope is included.

The ionic liquid employed in the processes of the present invention may be any ionic liquid capable of use in the dissolution of cellulose. In especially preferred embodiments, the ionic liquid employed is 1-ethyl-3-methyl imidazolium chloride, 1-ethyl-3-methyl imidazolium acetate (EMIM acetate), 1-butyl-3-methyl imidazolium chloride, 1-allyl-3-methyl imidazolium chloride, zinc chloride/choline chloride, 3-methyl-N-butyl-pyridinium chloride, benzyldimethyl (tetradecyl)ammonium chloride, 1-methylimidazolehydrochloride or mixtures thereof.

When cellulose is dissolved in the dopes employed in the processes of the present invention, the resulting cellulose solutions preferably have a viscosity which is sufficiently comparable to that of traditional viscose solutions to enable existing machinery to be utilised without the need for extensive retooling. In preferred embodiments of the present invention, the cellulose solutions have a viscosity of about 30000 centipoise or lower, preferably within the range of about 30000 to about 4000 centipoise, or about 12000 to about 5000 centipoise. More preferably, the cellulose solutions have a viscosity of less than about 25000, less than about 20000, less than about 15000, less than about 10000, less than about 8000, less than about 6000, less than about 4000, or even about 2000 centipoise or lower.

The degree of polymerisation (DP) of the cellulose starting material employed in the processes of the present invention can affect the temperature at which that cellulose material is at least partly dissolved in the dope. While cellulose materials having lower DP values are generally preferred, cellulose having high DP values can surprisingly be processed in the methods of the present invention. Thus, in preferred embodiments of the present invention, the DP of the cellulose starting material is less than 700, 600, 550, 500, 450 or more preferably 400.

One major advantage of the present invention is that relatively high quantities of cellulose may be processed. In preferred embodiments, proportion of cellulose which is present in the cellulose solution is 1 to 20% 5 to 15%, 8 to 12% or 9 to 10% all by weight of the cellulose solution. For the avoidance of any doubt, when reference is made to the proportion of cellulose present in the cellulose solution, the figure given relates to cellulose which is fully dissolved and also cellulose which is not dissolved or partially dissolved, i.e. the amount of cellulose added into the dope.

The cellulose material employed in the processes of the present invention is preferably in the form of pulp. The pulp may be obtained from any natural source, e.g. wood, cotton, bamboo, straw, etc. The cellulose material may comprise cellulose, hemi cellulose, starch, cellulose acetate or a mixture thereof.

Once a solution of cellulose is obtained, the casting process may be initiated. The temperature at which casting takes place may be the same as the temperature of the solution, or a temperature adjustment step may be performed to increase or decrease the temperature of the cellulose solution to the required level.

The cellulose solution, prior to casting, may be subjected to a filtration step, where the solution is forced through filtration apparatus to remove any impurities or precipitated or non-dissolved material. Thus, the use of solutions in which total dissolution is not achieved is still possible in film casting processes of the present invention.

The cellulose film preferably is formed by passing the cellulose solution through a die, preferably a slit die, to produce a sheet material. Any extrusion techniques and apparatus which may be employed to form a sheet of cellulose in solution may be employed.

The sheet is then contacted with a first casting solution. The first casting solution is preferably contained in a first casting bath and comprises an amount of non-solvent, ideally at least about 70% by weight of the casting solution. In certain embodiments, the balance is made up of a dope mixture, which preferably has essentially the same composition as the dope used to dissolve cellulose.

The non-solvent brings about the at least partial precipitation of cellulose from the cellulose solution, driving the majority of the dope out of the cellulose solution, and forming a cellulose film web.

The dope present in the first casting solution may solely be provided by the cellulose solution or may be added to the first casting solution.

At this stage, the cellulose material may still have a high temperature. There is also an exothermic effect when most ionic liquids are contacted with non-solvents, such as water, and thus cooling means to prevent the temperature of the casting solution from increasing excessively may be employed. The temperature of the casting solutions, especially the first casting solution, is preferably maintained at about 60° C. or lower.

Additionally, it has unexpectedly been found that the properties of films cast in the processes of the present invention can be controlled by adjusting the temperature of the casting solutions, especially the first casting solution. If a film is to be produced having a matt surface and/or which is opaque or hazy, the temperature of the casting solutions, especially the first casting solution should be maintained around 40 to 60° C. If a clear, glossy film having a higher density is to be produced, the casting solutions, especially the first casting solution should be maintained at a lower temperature, around 20 to 30° C.

The cellulose sheet is preferably then passed, via a series of rollers to a second casting bath, which contains a higher proportion of non-solvent, ideally at least about 90%, with the balance comprising a dope mixture that may or may not have the same composition as the dope used to prepare the cellulose solution. As the sheet passes through this second bath, the precipitation of the cellulose from the dope will continue, further reducing the amount of dope present in the film web. Additional casting baths, each containing an increasing proportion of non-solvent may be used until the cellulose film contains an acceptably low proportion of dope.

As the cellulose sheet is passed through the casting baths, dope will be deposited therein, which will increase the proportion of dope in the casting solutions. To maintain the predetermined proportions of non-solvent in the casting baths, a countercurrent of non-solvent is fed back through the casting baths.

Any substance which elicits the precipitation of cellulose from the dope may be used as a non-solvent in casting solutions of the present invention. In preferred arrangements, the non-solvent is protic and examples of protic materials which may be employed as non-solvents include water, ethanol, methanol, propanol.

The dope may be recovered from the casting baths using any techniques known to those skilled in the art. For example, in an embodiment of the present invention where the dope comprises EMIM acetate as the ionic liquid, DMSO as the polar aprotic component and water as a non-solvent, EMIM acetate may be separated from DMSO and water using thin film evaporation. DMSO and water may then be separated by fractional distillation.

The following examples are intended to illustrate further certain embodiments of the invention and are not limiting in nature. Those skilled in the art will recognise, or be able to ascertain, using no more than routine experimentation, numerous equivalents to the specific examples described herein.

### Example 1

A dope was prepared comprising DMSO and EMIM acetate in a ratio of 80:20 by weight of the dope. Cellulose having a degree of polymerisation (DP) of 380 was added in an amount of 9% by weight of the cellulose solution.

The mixture was heated to 90° C. and the cellulose was almost completely dissolved after 25 minutes with less than 10 fibres/gram and no lumps or gels were observed. This is surprising given that temperatures of 105° C. were required to elicit dissolution of cellulose in similar dopes in US2009/0084509.

On cooling the solution remained fluid, the ball fall viscosity of the solution was measured over a range of temperatures, the results can be seen below.

| Temperature (° C.) | Ball Fall Velocity (s) | Viscosity (cps) |
|---|---|---|
| 20 | 188 | 33,905 |
| 36 | 87 | 15,690 |
| 55 | 36 | 6,492 |
| 74 | 18 | 3,246 |
| 87 | 11 | 1,984 |

### Example 2

A dope having the same composition as that employed in Example 1 was prepared. The maximum temperature of dissolution was 60° C. After 15 minutes at 60° C., the cellulose was partially dissolved but had a moderately high fibre count. After 60 minutes at 60° C. the solution had not changed.

### Example 3

A dope having the same composition as those employed in Examples 1 and 2 was prepared. The temperature of dissolution was incrementally increased and held for approximately 15 minutes at each stage. At each stage a sample was taken and studied for solution quality and stability. The results are provided below:

| Temperature (° C.) | Observations |
|---|---|
| 50 | The cellulose was partially dissolved, but having |
| | a moderately high fibre count and was turbid. The |
| | solution gelled upon cooling to room temperature. |
| 60 | The solution had no turbidity but still had a |
| | relatively high fibre count. The solution gelled |
| | upon cooling to room temperature, but could be |
| | made fluid again on re-heating |
| 70 | As per 60° C. |
| 75 | The solution remained hazy due to a relatively |
| | high fibre count but unlike previous stages, did |
| | not gel upon cooling to room temperature. |
| 80 | As per 75° C. |
| 85 | At 85° C. the solution is completely free from |
| | undissolved fibres and stable on cooling to room |
| | temperature. At these conditions no filtration |
| | would be required. |
| 90 | As per 85° C. |

The results of this test illustrates that a dope comprising only 20% ionic liquid by weight of the dope can retain significant amounts of cellulose in solution at relatively low temperatures. Although complete dissolution was not observed at temperatures of 50° C. to 80° C., the solutions obtained at those temperatures could still be employed to prepare cellulose films if the solution was subjected to a filtration step or if the desired quality of the film was not high.

### Example 4

A dope was prepared comprising DMSO and EMIM acetate in a ratio of 50:50 by weight of the dope. Cellulose having a degree of polymerisation (DP) of 380 was added in an amount of 9% by weight of the cellulose solution.

It was noted that the viscosity of the solutions formed from a dope having a weight ratio of DMSO to EMIM acetate of 50:50 was higher than that of the solutions recited in the preceding examples. It is believed that this increase in viscosity arises as a result of the increase in the proportion of ionic liquid and/or the reduction in swelling of the cellulose, as a result of the lower proportion of DMSO which was employed. Again, the viscosity of the solution was measured across a range of temperatures

| Temperature (° C.) | Ball Fall Velocity (s) | Viscosity (cps) |
|---|---|---|
| 20 | 698 | 125,880 |
| 38 | 270 | 48,693 |
| 55 | 128 | 23,084 |
| 73 | 49 | 8,837 |
| 93 | 27 | 4,869 |

These results demonstrate that an increase in the proportion of ionic liquid present results in an increase in viscosity. However, the obtained viscosity values are still comparable to those observed in traditional viscose solutions, meaning that the exemplified solutions should be suitable for use in viscose casting equipment.

### Example 5

A dope was prepared comprising DMSO and EMIM acetate in a ratio of 60:40 by weight of the dope. A quantity of cellulose having a degree of polymerisation (DP) of 380 was added in an amount of 9% by weight of the cellulose solution.

Ball fall viscosity measurements were taken over a range of temperatures and the results are provided below

| Temperature (° C.) | Ball Fall Velocity (s) | Viscosity (cps) |
|---|---|---|
| 20 | 485 | 87,467 |
| 33 | 229 | 41,299 |
| 45 | 96 | 17,313 |
| 55 | 65 | 11,722 |
| 74 | 34 | 3,132 |
| 93 | 17 | 3,066 |

### Example 6

A dope was prepared comprising DMSO and EMIM acetate in a ratio of 70:30 by weight of the cellulose. A quantity of cellulose having a degree of polymerisation (DP) of 380 was added in an amount of 9% by weight of the cellulose solution.

The temperature of dissolution was incrementally increased and held for approximately 15 minutes at each stage. At each stage a sample was taken and studied for solution quality and stability. The results are provided below:

| Temperature (° C.) | Observations |
|---|---|
| 40 | The cellulose was almost totally dissolved, with |
| | few small fibres still present and a slightly hazy |
| | solution, on cooling to room temperature the solu- |
| | tion remained fluid and stable, but would require |
| | filtration prior to casting |
| 50 | As per 40° C. |
| 55 | At 55° C. the solution is completely free from un- |
| | dissolved fibres and stable/fluid on cooling to room |
| | temperature, at these conditions no filtration would |
| | be required |

These results show the surprising reduction in cellulose dissolution temperatures when the process of the present invention is employed. Total dissolution was observed after 45 minutes at only 55° C.

Ball fall measurements were taken over a range of temperatures the results of which are provided below

| Temperature (° C.) | Ball Fall Velocity (s) | Viscosity (cps) |
|---|---|---|
| 20 | 308 | 55,546 |
| 36 | 115 | 20,740 |
| 55 | 51 | 9,198 |
| 74 | 24 | 4,328 |
| 93 | 12 | 2,164 |

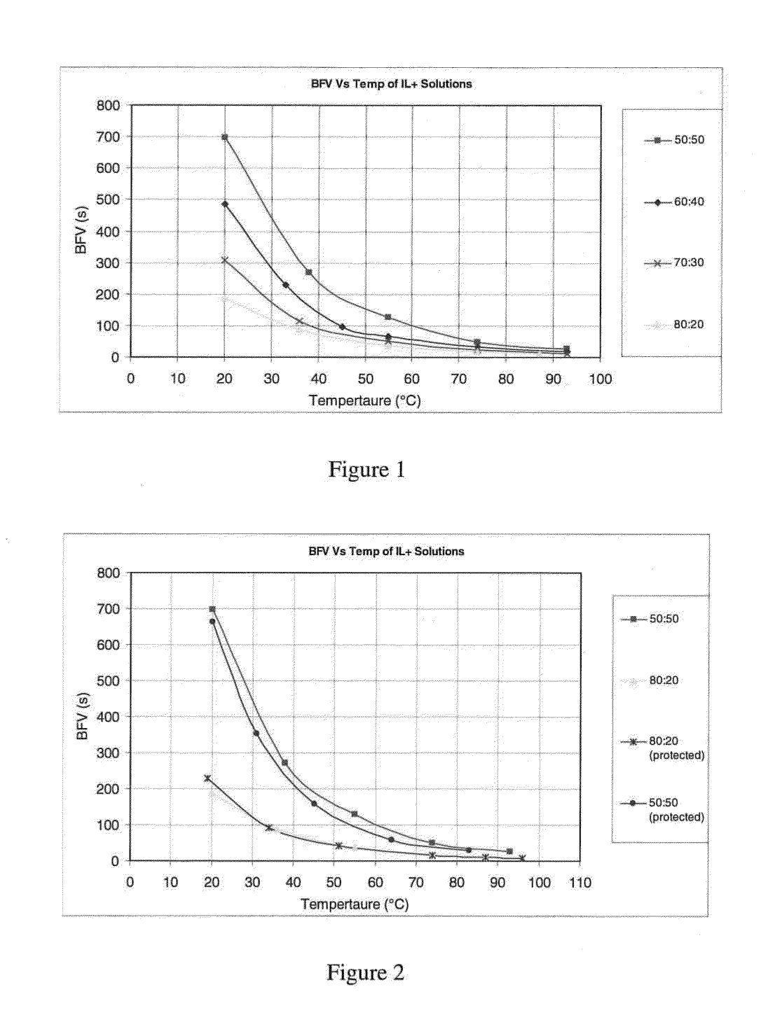

A chart illustrating the ball fall velocities reported in Examples 1, 4, 5 and 6 is provided as FIG. 1.

### Example 7

A dope was prepared comprising DMSO and EMIM acetate in a ratio of 75:25 by weight of the dope. A quantity of cellulose having a degree of polymerisation (DP) of 380 was added in an amount of 9% by weight of the cellulose solution.

The temperature of dissolution was incrementally increased and held for approximately 15 minutes at each stage. At each stage a sample was taken and studied for solution quality and stability. The results are provided below:

| Temperature (° C.) | Observations |
|---|---|
| 40 | The solution had no turbidity but still had a |
| | relatively high fibre count, and gelled upon |
| | cooling to room temperature |
| 50 | As per 40° C. |
| 60 | The solution remained hazy due to a moderately |
| | high fibre count. Unlike previous stages, the |
| | solution did not gel upon cooling to room |
| | temperature. |
| 70 | At 70° C. the solution is completely free from |
| | undissolved fibres and is stable on cooling to |
| | room temperature. |

### Example 8

Tests were performed to investigate the stability of cellulose solutions employed in the processes of the present invention. Those solutions comprised dopes having a ratio of DMSO to EMIM acetate of 80:20 and 50:50 by weight of the dope. A quantity of cellulose having a degree of polymerisation (DP) of 380 was included in the solution in an amount of 9% by weight of the cellulose solution.

Ball fall velocity measurements were then made in these solutions at varying temperatures in both an ambient atmospheric environment (i.e. in the presence of air) and in a protected environment. The protected environment was established by providing a blanket of nitrogen and a vacuum. The results of these measurements are provided in FIG. 2.

While the ball fall test is used to measure the viscosity of a liquid, viscosity also provides a useful indication of the stability of dopes and cellulose solutions. As can be seen from the chart in FIG. 2, the effect that the protected environment had on ball fall velocity was negligible. Accordingly, this suggests that the dopes of the present invention can be stored, handled and used without the need to provide an inert atmosphere.

### Example 9

A solution having the composition recited in Example 6 above was prepared. The viscosity of that solution at 55° C. was measured and the ball fall velocity was 50 seconds.

The solution was stored in an oven at 55° C. under ambient atmospheric conditions and the viscosity was measured after 11 days and 23 days. After 11 days, no reduction in viscosity was observed. After 23 days, the viscosity had reduced to 48 seconds. Thus, it appears that the solutions employed in the processes of the present invention exhibit only a minor degree of thermal degradation, especially when compared to a pure ionic-liquid dope, and are therefore suitable for repeated use in the formation of cellulose films.

### Example 10

It had been noted that the rate of oxidation of pure ionic liquid solutions undergoing high shear blending under ambient atmospheric conditions was unacceptably high. To minimise oxidation, it had been necessary to remove oxygen from the environment prior to the initiation of high-shear mixing.

To investigate whether the solutions employed in the processes of the present invention were susceptible to oxidation during high-shear mixing, a solution was prepared having the same composition as that outlined in Example 6 above.

The viscosity of the solution was measured at 60° C. and found to be 43 seconds (ball fall velocity). The solution was stirred at 2000 rpm for three hours under a nitrogen blanket, to exclude the presence of oxygen. The temperature of the solution was maintained at 60° C. As expected, the viscosity of the solution was unchanged.

The same procedure was repeated, except that the solution was stirred for three hours under ambient atmospheric conditions. Surprisingly, the viscosity of the solution was unchanged.

These tests were repeated at 90° C. and the outcome was the same, i.e. the solutions employed in the processes of the present invention were not susceptible to oxidation when stirred under high-shear conditions.

### Example 11

Tests were performed to investigate the effect of varying amounts of cellulose on the viscosity of the solutions employed in the processes of the present invention. Solutions including cellulose and a dope were prepared. The dope consisted of DMSO and EMIM acetate in a ratio of 70:30 by weight of the dope. The solution included cellulose in concentrations ranging from 9.0 to 9.9% by weight of the cellulose solution.

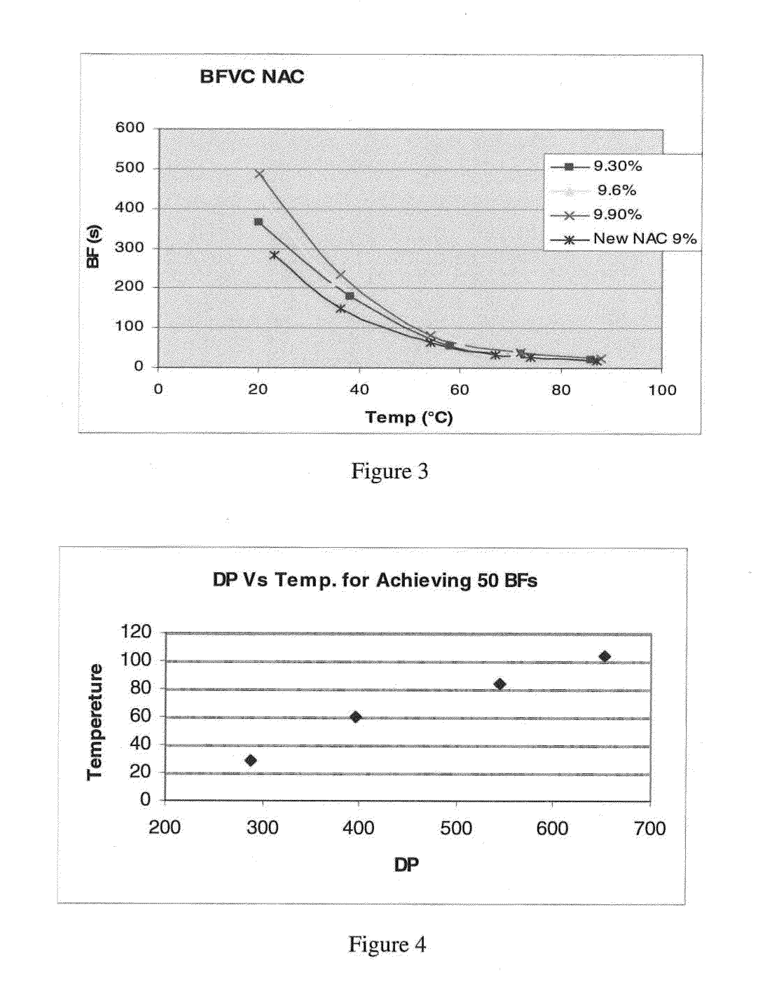

Ball fall velocity viscosity measurements were made in each of these solutions across a range of temperatures. Those measurements are provided in FIG. 3.

As can be seen from that chart, at lower temperatures, the proportion of cellulose included in the solution has a notable effect on viscosity. However, as temperatures are increased, the effect on viscosity of cellulose concentration becomes increasingly negligible in the solutions employed in the processes of the present invention.

### Example 12

Tests were performed to investigate the effect of the degree of polymerisation (DP) of cellulose on the viscosity of the solutions employed in the processes of the present invention.

Solutions including cellulose and a dope were prepared. The dopes consisted of DMSO and EMIM acetate in a ratio of 70:30 by weight of the dope. The solutions included 9.0% cellulose by weight of the cellulose solution. The solutions varied in terms of the DP of the cellulose.

For each of the solutions, the temperature necessary to achieve a viscosity of 50 seconds (ball fall velocity) was determined and the results are provided in FIG. 4.

While the use of cellulose having a low DP (e.g. 300-400) is preferred, as a low viscosity solution can be obtained at a relatively low temperature, the results shown in FIG. 4 confirm that cellulose having a higher DP, which may have been unsuitable for use in conventional ionic liquid dopes, can be dissolved with only a slight increase in dissolution temperature.

### Example 13

The effect of casting bath temperature on film quality and structure was investigated by preparing a cellulose solution including cellulose and a dope. The dope consisted of DMSO and EMIM acetate in a ratio of 70:30 by weight of the dope. The cellulose solution included 9.0% cellulose by weight of the cellulose solution.

The cellulose solution was cast, using a glass plate and a casting blade, into baths of pure water which each had different temperatures ranging from 20° C. to 50° C. The resulting films were analysed and the following observations were made:

| Casting Solution | Density | |
|---|---|---|
| Temperature (° C.) | of Film | Comments |
| 20 | 1.64 | A clear wet gel was formed, which |
| | | upon drying produced a film which |
| | | was crystal clear and glossy. |
| 30 | 1.5 | The formed wet gel was slightly |
| | | more opaque although it dried clear. |
| | | The resulting film was slightly less |
| | | glossy than the film produced in the |
| | | 20° C. casting solution. |
| 40 | / | As for 30° C. |
| 50 | 1.41 | The wet gel was very opaque and hazy |
| | | and remained so upon drying. |

Thus, it has been found that the density of cellulose films can be controlled by adjusting the temperature of the casting solution. It also has been found that casting solution temperatures having an excessive temperature (more than 50° C. for casting solutions of pure water) are likely to result in films that have rough surfaces and intrinsic faults throughout.

The temperature of the cellulose solution which is passed into the casting solution is likely to have a temperature greater than 50° C. Further, with most ionic liquids and non-solvents, an exothermic reaction occurs when they are contacted. Accordingly, steps should be taken to ensure that the temperature of the casting solution is retained at the predetermined level.

1. A process for producing a cellulose film in which:
a) cellulose is at least partly dissolved at a temperature of about 100° C. or lower in a dope comprising an ionic liquid and a cosolvent to form a cellulose solution, wherein said cosolvent comprises a polar aprotic component, and
b) cellulose film is cast from the cellulose solution.

2. The process of claim 1, wherein the temperature of dissolution is about 90° C. or lower.

3. The process of claim 1, wherein the temperature of dissolution is about 80° C. or lower.

4. The process of claim 1, wherein the temperature of dissolution is about 70° C. or lower.

5. The process of claim 1, wherein step a) and/or step b) are performed under ambient atmospheric conditions.

6. The process of claim 1, wherein the dope comprises about 50% or less ionic liquid by weight of the dope.

7. The process of claim 1, wherein the dope comprises about 20% or more ionic liquid by weight of the dope.

8. The process of claim 1, wherein the dope comprises between 20% and 50% ionic liquid by weight of the dope.

9. The process claim 1, wherein the dope comprises about 25% to about 45% ionic liquid by weight of the dope.

10. The process of claim 1, wherein the dope comprises about 25% to about 40% ionic liquid by weight of the dope.

11. The process of claim 1, wherein the dope comprises about 25% to about 35% ionic liquid by weight of the dope.

12. The process of claim 1, wherein the cellulose and the polar aprotic component are pre-mixed prior to formation of the dope.

13. The process of claim 1, wherein the cosolvent consists exclusively or essentially of the polar aprotic component.

14. The process of claim 1, wherein the polar aprotic component is selected from the group consisting of dimethyl sulfoxide (DMSO), tetrahydrofuran (THF), dimethylacetamide (DMAc), dimethylformamide (DMF), formamide, N-methylmorpholineoxide, pyridine, acetone, dioxane, N-methylpyrrolidone, piperyline sulfone and hexamethylphosphoramide or mixtures thereof.

15. The process of claim 1, wherein the dope comprises a base.

16. The process of claim 15, wherein the base is a nitrogen containing base.

17. The process of claim 15, wherein the base is selected from the group consisting of pyridine, ammonia, piperidine, morpholine, diethanolamine or triethanolamine, pyridine, triethylamine, urea or mixtures thereof.

18. The process of claim 15, wherein the base is present in an amount of 1% to 10% by weight of the dope.

19. The process of claim 15, wherein the base is present in an amount of 3% to 8% by weight of the dope.

20. The process of claim 1, wherein the ionic liquid is selected from the group consisting of 1-ethyl-3-methyl imidazolium chloride, 1-ethyl-3-methyl imidazolium acetate (EMIM acetate), 1-butyl-3-methyl imidazolium chloride, 1-allyl-3-methyl imidazolium chloride, zinc chloride/choline chloride, 3-methyl-N-butyl-pyridinium chloride, benzyldimethyl (tetradecyl)ammonium chloride, 1-methylimidazolehydrochloride or mixtures thereof.

21. The process of claim 1, wherein the cellulose solution has a viscosity of about 25000 centipoise or lower.

22. The process of claim 1, wherein the degree of polymerisation of the cellulose is about 500 or lower.

23. The process of claim 1, wherein the degree of polymerisation of the cellulose is about 400 or lower.

24. The process of claim 1, wherein the cellulose solution comprises about 1% to about 20% cellulose by weight of the cellulose solution.

25. The process of claim 1, wherein the cellulose solution comprises about 5% to 15% cellulose by weight of the cellulose solution.

26. The process of claim 1, wherein the cellulose solution comprises about 8% to 12% cellulose by weight of the cellulose solution.

27. The process of claim 1, wherein the cellulose solution is filtered prior to being cast.

28. The process of claim 1, wherein casting step comprises contacting the cellulose solution with a first casting solution comprising a non-solvent to produce regenerated cellulose.

29. The process of claim 28, wherein the non-solvent is water.

30. The process of claim 28, wherein the first casting solution is maintained at a temperature of 60° C. or lower.

31. The process of claim 28, wherein the first casting solution is maintained at a temperature of 35° C. or lower.

32. The process of claim 28, wherein the first casting solution comprises about 70% or higher of non-solvent by weight of the first casting solution.

33. The process of claim 28, wherein the first casting solution comprises a dope mixture comprising ionic liquid and a cosolvent, the cosolvent comprising a polar aprotic component.

34. The process of claim 33, wherein the dope mixture has essentially the same composition as the dope in which cellulose is at least partly dissolved in step a).

35. The process of claim 28, wherein the regenerated cellulose is removed from the first casting solution and contacted with a second casting solution, said second casting solution comprising a higher proportion of non-solvent than said first casting solution.

36. The process of claim 28, wherein the proportion of non-solvent present in the first and second casting solutions is maintained by the provision of a countercurrent flow of non-solvent to the first and second casting solutions.

37. The process of claim 28, wherein ionic liquid is recovered from the first and/or second casting solutions by removing a portion of said first and/or second casting solutions and performing thin film evaporation to extract ionic liquid therefrom to leave a mixture of non-solvent and cosolvent from the dope.

38. The process of claim 37, wherein the cosolvent is recovered from the mixture of non-solvent and cosolvent using fractional distillation.

39. A dope for dissolving cellulose comprising a polar aprotic component and between 20% and 50% by weight of the dope of an ionic liquid.

40. The dope of claim 39, wherein the ionic liquid is EMIM acetate and the polar aprotic component is DMSO.
